(19) United States
(12) Patent Application Publication
(10) Pub. No.: US 2024/0248528 A1
(43) Pub. Date: Jul. 25, 2024

(54) Artificial Reality Entry Spaces for Virtual Reality Experiences

(71) Applicant: Meta Platforms Technologies, LLC, Menlo Park, CA (US)

(72) Inventors: Nicholas WALLEN, Atlanta, GA (US); Christopher Richard TANNER, High Land Ranch, CO (US); Ata DOGAN, Seattle, WA (US)

(21) Appl. No.: 18/159,312

(22) Filed: Jan. 25, 2023

(51) Int. Cl. G06F 3/01; G06T 19/00

(52) U.S. Cl. CPC G06F 3/011; G06T 19/006

(57) ABSTRACT

Aspects of the present disclosure can provide portals to virtual reality (VR) experiences from within an artificial reality (XR) entry space, such as mixed reality (MR) or augmented reality (AR). Some implementations can allow a user to move between pre-established physical spaces that are mapped to certain activities and tagged content. Some implementations can tag the content to a particular real-world location based on user input, a system suggestion, or the system simply picking up where the user left off in an AR or MR experience in that location. In some implementations, the content can launch a corresponding VR experience. For example, a virtual object can appear overlaid on a user's real-world room. By grabbing the virtual object, some implementations can automatically launch a VR experience. In another example, some implementations can automatically display a virtual portal to a VR co-working experience when the user sits at her desk.

### TECHNICAL FIELD

The present disclosure is directed to artificial reality (XR) entry spaces for virtual reality (VR) experiences.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for providing an artificial reality (XR) entry space for a virtual reality (VR) experience.

FIG. 6 is a conceptual diagram of an example view on an artificial reality (XR) device of a virtual tablet overlaid on a pass-through visual of a real-world environment.

FIG. 7A is a conceptual diagram of an example view on an artificial reality (XR) device of content overlays overlaid on a pre-mapped portion of a physical space in a real-world environment.

FIG. 7B is a conceptual diagram of an example view on an artificial reality (XR) device of a virtual reality (VR) experience accessed from a virtual portal overlaid on a pre-mapped portion of a physical space in a real-world environment.

FIG. 8A is a conceptual diagram of an example view on an artificial reality (XR) device of a guardian overlaid on a pre-mapped portion of a physical space in a real-world environment.

FIG. 8B is a conceptual diagram of an example view on an artificial reality (XR) device of a virtual reality (VR) experience automatically launched in response to a user interaction with a guardian overlaid on a pre-mapped portion of a physical space in a real-world environment.

FIG. 9 is a conceptual diagram of an example view of a real-world environment including users of artificial reality (XR) devices accessing virtual reality (VR) experiences at respective pre-mapped portions of a physical space.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure can provide virtual travel to virtual reality (VR) experiences from within an artificial reality (XR) entry space, such as from a mixed reality (MR) or augmented reality (AR) experience. A user can move between pre-established physical spaces that are mapped to certain activities and tagged content. The content can be tagged to a particular real-world location (e.g., a room, a couch, a desk, etc.) based on user input, a system-generated suggestion, or the system simply picking up where the user left off in an MR experience in that location. In some implementations, the content can launch a corresponding VR experience.

In some implementations, an XR entry space system can provide an XR entry space for a VR experience by initially detecting activation (e.g., powering on) of an XR device by a user and/or detecting donning of an XR device by a user (e.g., placing of an XR head-mounted display on the user's head). Upon activation or donning of the XR device, the XR device can at least partially display a pass-through view (e.g., mixed reality or augmented reality) of a real-world environment of the user, which can be overlaid in some implementations with a virtual home screen. The XR entry space system can identify a portion of a physical space (e.g., a room) in the pass-through view of the real-world environment, such as a couch, a table, a floor, etc. In some implementations, the portion can be mapped to one or more particular VR experiences, such as previously mapped by the user, the XR entry space system, the XR device, etc. In some implementations, the portion can be mapped to one or more particular VR experiences “on the fly,” such as by applying a machine learning model to the portion of the physical space to identify one or more likely VR experiences associated with that portion of the physical space.

The XR entry space system can display a content overlay corresponding to the mapped VR experience at the portion of the physical space. The content overlay can include one or more of, for example, a virtual object (e.g., a virtual pool stick, a virtual sword, a virtual ball, etc.), a virtual portal (e.g., a graphical and/or textual indicator of a VR experience), a guardian (e.g., a boundary of the portion of the physical space, a floor area clear of physical objects in which the VR experience can be accessed without damage or injury), etc. The XR entry space system can determine that user input received at the XR device interacts with the content overlay. For example, the XR entry space system can determine that the user has touched a virtual object, entered a guardian, walked through a virtual portal, etc. In response to determining that the user input interacts with the content overlay, the XR entry space system can launch the VR experience mapped to the portion of the physical space corresponding to the content overlay. The VR experience can present an artificial environment replacing the pass-through view of the real-world environment on the XR device, i.e., can be fully computer-generated and immersive.

For example, the XR entry space system can overlay a virtual microphone on a user's real-world room. When the user grabs the virtual microphone, some implementations can automatically launch a karaoke experience in VR. In another example, the user's entry into a particular guardian (e.g., the user sitting at a desk) can cause a virtual portal to a VR experience (e.g., a virtual workspace) to appear. The user can then access the VR experience via the portal. In still another example, the user's entry into a particular guardian (e.g., a couch in a living room) can automatically launch a particular VR experience (e.g., a three-dimensional movie). In some implementations, the VR experience can be launched at a particular point where the user last left off (e.g., a particular time in a three-dimensional movie that was partially watched by the user).

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific improvements in the field of artificial reality. Some implementations allow a user to traverse the real-world environment using a pass-through view (as in mixed reality and/or augmented reality), and can automatically suggest virtual reality (VR) experiences that can be relevant to the user when the user is in a particular area of the real-world environment. Some implementations can apply a machine learning model to determine which VR experience may be relevant to a user in a particular space, and can continuously update and refine the model to make better predictions based on normal usage of the XR device. Further, in some implementations, the user can launch a particular VR experience with a single interaction, such as a selection, a movement, a gesture, a gaze, an audible announcement, etc. Thus, some implementations can eliminate the need for a user to access, scroll through, and select a particular VR experience from a virtual menu, which can be time consuming, intrusive, and partially block the pass-through view of the real-world environment. By eliminating the need for a user to traverse a virtual menu to launch a relevant VR experience, compute resources, such as processing, display, and power resources needed to render the display of the virtual menu, are conserved. In some implementations, the compute resources can instead be focused on more important, necessary, and/or fundamental tasks performed by the XR device, thereby improving processing speed, latency, and performance on the XR device.

Some implementations restore a VR experience from a saved state that corresponds to the user's last interaction with the VR experience. For example, the user can enter a predefined guardian (e.g., sit on a couch), and a VR video game can be loaded and restored to the last save state of the user's previous gaming session. These implementations provide a seamless user experience that reduces or eliminates conventional friction points, such as manually loading the game via several menus, manually selecting the correct save state to restore from among several save states, etc.

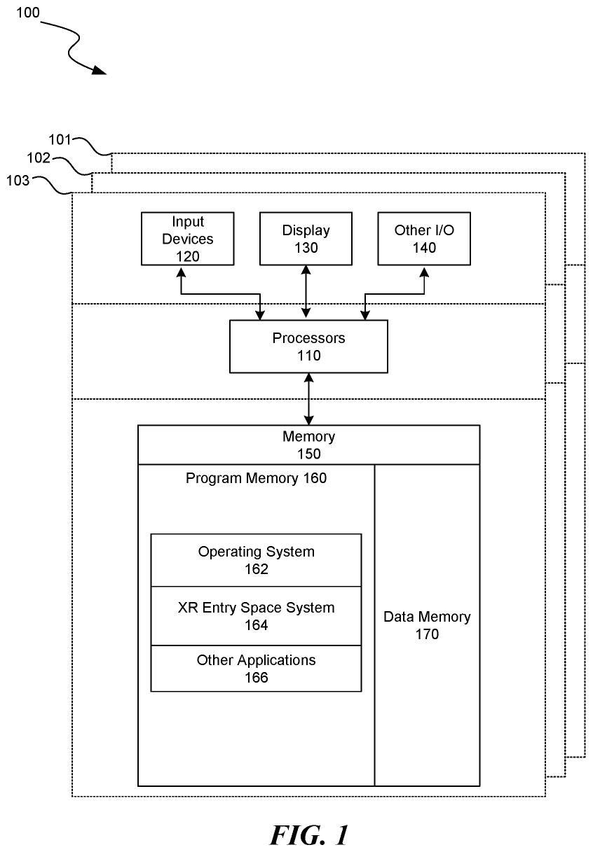

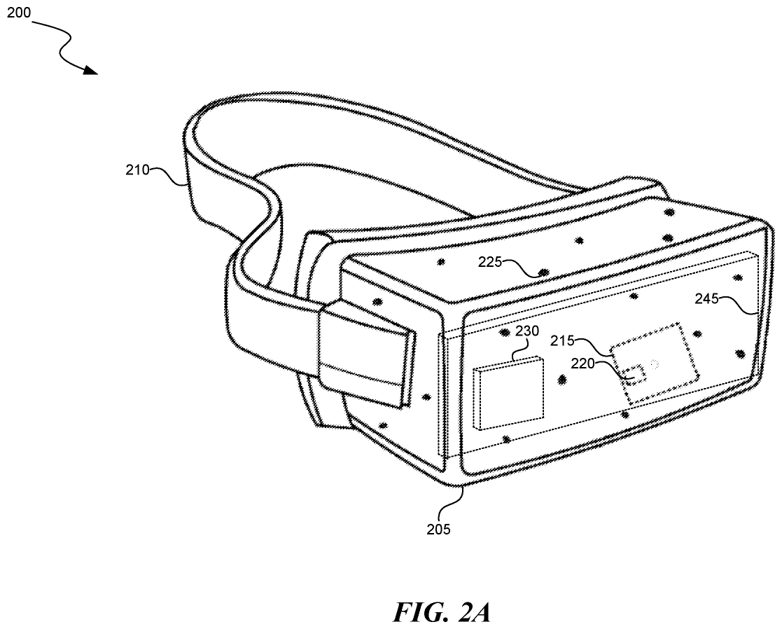

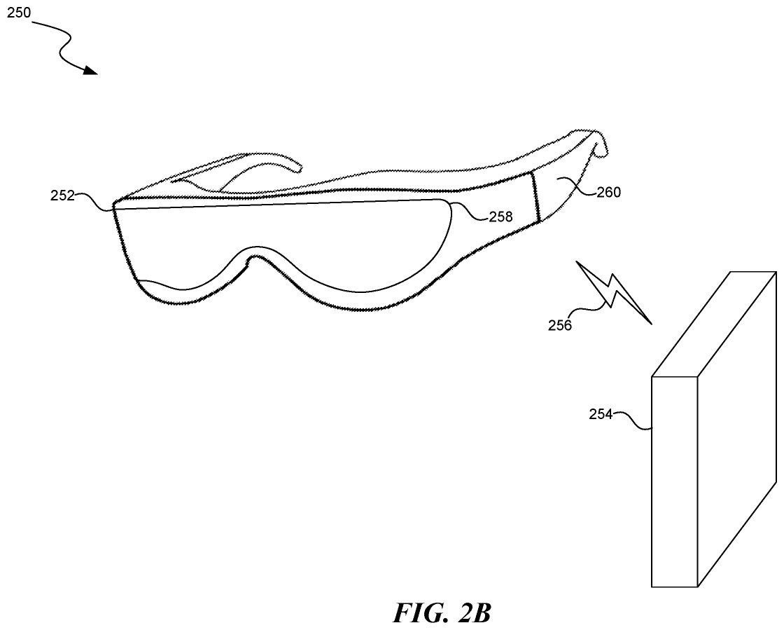

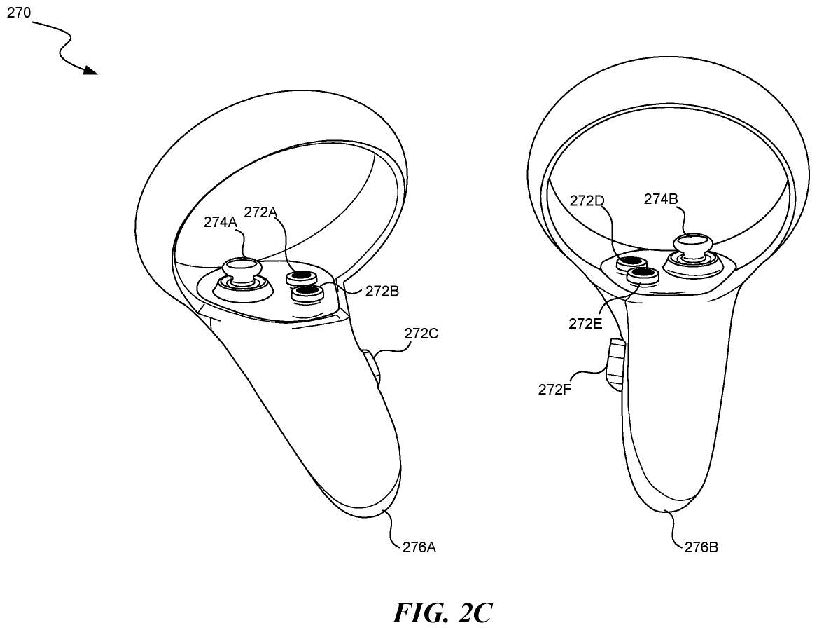

Several implementations are discussed below in more detail in reference to the figures. FIG. 1 is a block diagram illustrating an overview of devices on which some implementations of the disclosed technology can operate. The devices can comprise hardware components of a computing system 100 that can provide an artificial reality (XR) entry space for a virtual reality (VR) experience. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, artificial reality (XR) entry space system 164, and other application programs 166. Memory 150 can also include data memory 170 that can include, e.g., physical space data, pass-through data, content data, mapping data, user input data, interaction data, virtual reality (VR) experience data, rendering data, virtual object data, guardian data, virtual portal data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

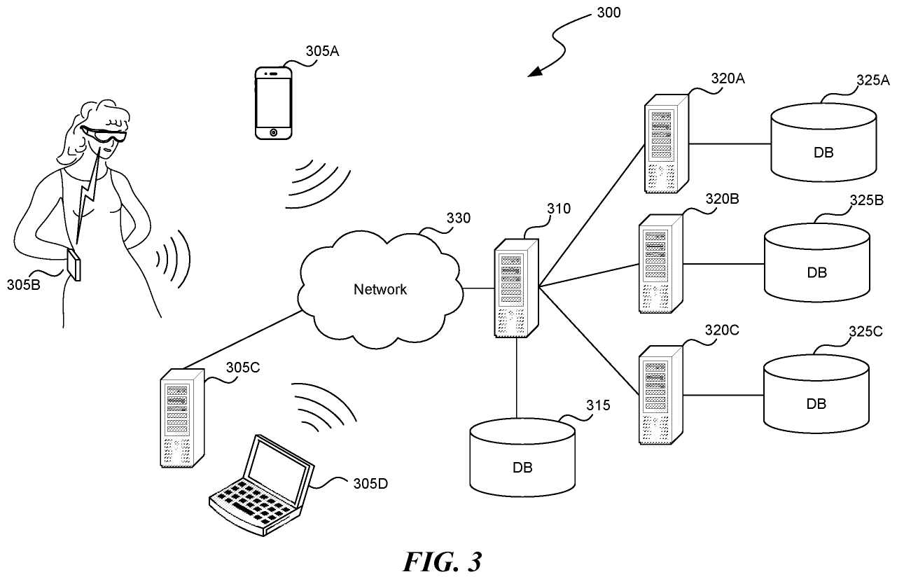

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

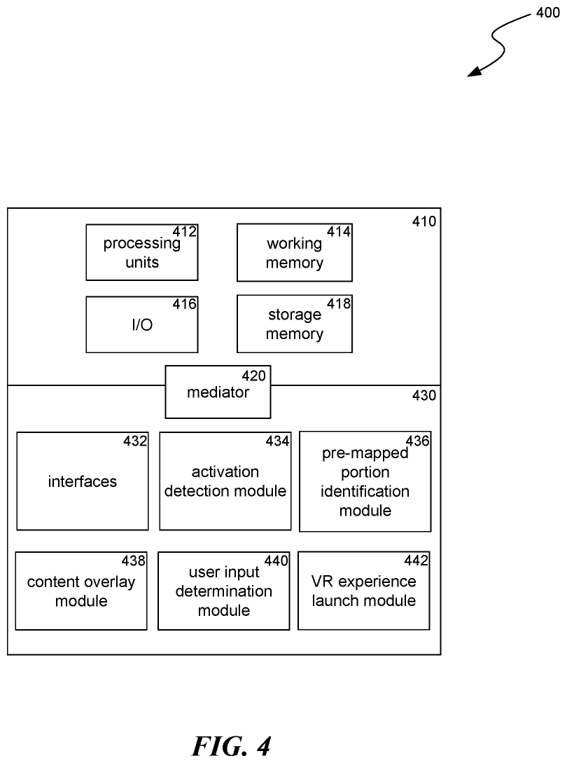

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing an artificial reality (XR) entry space for a virtual reality (VR) experience. Specialized components 430 can include activation detection module 434, pre-mapped portion identification module 436, content overlay module 438, user input determination module 440, VR experience launch module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Activation detection module 434 can detect activation or donning of an artificial reality (XR) device by a user. Activation detection module 434 can detect activation of the XR device by, for example, detecting pressure on a power button integral with the XR device, toggling of a power switch integral with the XR device, detecting power being supplied by a battery or outlet to the XR device, detecting movement of the XR device that activates or awakens the XR device from a sleep mode, detecting the execution of one or more software subroutines related to activation of the XR device, etc. Activation detection module 434 can detect donning of the XR device by, for example, accessing sensor data captured by one or more sensors integral with the XR device indicative of the XR device being placed around the head and/or face of the user, detecting a software workflow related to donning of the XR device (e.g., initiation of a display via the XR device), etc. The one or more sensors can include, for example, one or more of sensors of an inertial measurement unit (IMU), pressure sensors, temperature sensors, accelerometers, gyroscopes, accelerometers, electromyogram (EMG) sensors, etc.

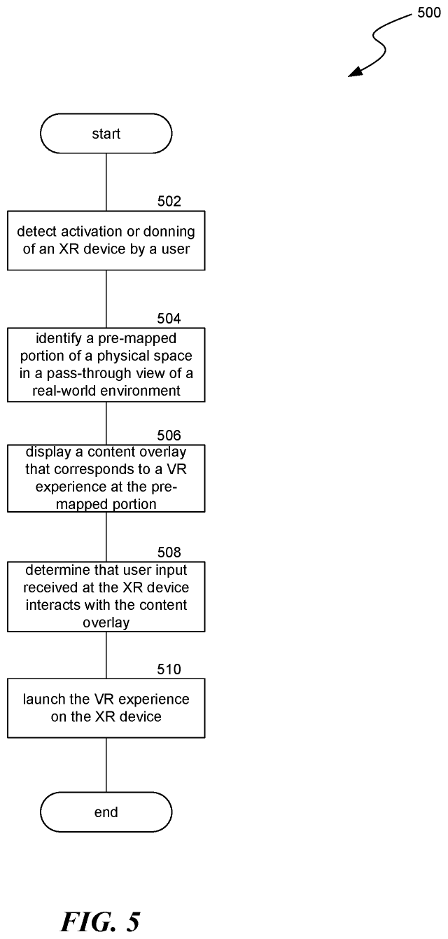

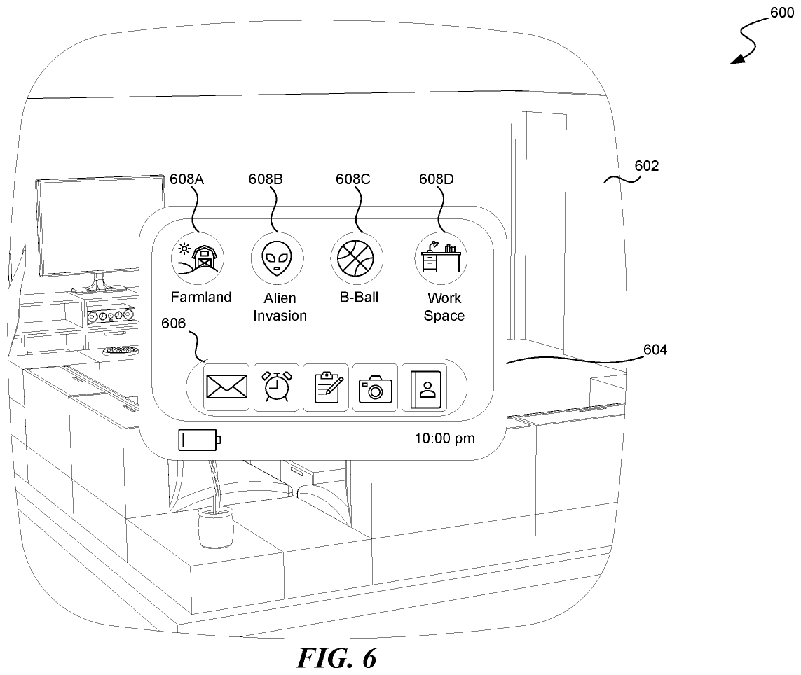

In some implementations, upon detection of activation or donning of an XR device by a user, activation detection module 434 can automatically at least partially display a pass-through view of a real-world environment of the user. In some implementations, the pass-through view can be captured by one or more cameras integral with or in operable communication with the XR device, then streamed to the display of the XR device, as in augmented reality (AR). In some implementations, the pass-through view can be a true view of the real-world environment as seen by the user through the display of the XR device, as in mixed reality (MR). In some implementations, upon detection of activation or donning of an XR device by a user, activation detection module 434 can automatically display a virtual tablet or home screen overlaid on the pass-through view of the real-world environment, as described further herein with respect to FIG. 6. Further details regarding detecting activation or donning of an XR device by a user are described herein with respect to block 502 of FIG. 5.

Pre-mapped portion identification module 436 can identify a pre-mapped portion of a physical space in the pass-through view of the real-world environment. The physical space can be any physical indoor or outdoor area within the real-world environment, such as a room. The pre-mapped portion of the physical space can be any portion of the physical space within the pass-through view, such as a table, a desk, a counter, a floor, a wall, a chair, a couch, any predefined region of any of these, any predefined volume of any of these, etc., or any portion(s) thereof. The pre-mapped portion can be mapped to a virtual reality (VR) experience. In some implementations, the user of the XR device previously mapped the pre-mapped portion to the VR experience, such as through manual selection on the XR device. In some implementations, the XR device (or any other device or system in operable communication with the XR device) previously mapped the pre-mapped portion to the VR experience automatically without user instruction to do so, such as based on: a suggestion; a prediction (e.g., made by applying a machine learning model to various data points associated with the user, the VR experience, the pre-mapped portion, the physical space, contextual factors, etc.); one or more features, types, requirements, and/or categories of the pre-mapped portion, the physical space, or the VR experience; and/or the like.

In some implementations, the portion of the physical space can be mapped to a VR experience in real-time or near real-time. For example, a computer vision model can detect and identify one or more objects of the real-world environment that comprise predefined rules for mapping certain objects or object types to certain VR experiences. An example rule includes mapping a recognized couch object to a VR gaming experience. Another example rule includes mapping one or more recognized desk objects (e.g., recognized object comprising a work chair object type and a recognized object comprising a flat surface proximate to the work chair object) to a virtual workspace. In these examples, the predefined mapping can occur in real-time or near real-time relative to the display of a content overlay that corresponds to the mapped VR experience.

In some implementations, pre-mapped portion identification module 436 can identify multiple pre-mapped portions of a physical space in the pass-through view of the real-world environment. In such implementations, each of the pre-mapped portions can be mapped to a VR experience. In some implementations, at least some of the pre-mapped portions can be mapped to the same VR experience. In some implementations, at least some of the pre-mapped portions can be mapped to different VR experiences. In some implementations, two or more pre-mapped portions can at least partially overlap in the physical space. For example, a first pre-mapped portion can have an overlapping portion with a second pre-mapped portion of the physical space. In some implementations, the first pre-mapped portion can be mapped to a first VR experience, the second pre-mapped portion can be mapped to a second VR experience, and the overlapping portion can be mapped to both the first VR experience and the second VR experience. Further details regarding identifying one or more pre-mapped portions of a physical space in a pass-through view of a real-world environment are described herein with respect to block 504 of FIG. 5.

Content overlay module 438 can display a content overlay that corresponds to the VR experience, mapped to the pre-mapped portion of the physical space, at the pre-mapped portion of the physical space. The content overlay can include any virtual two-dimensional or three-dimensional content, such as one or more virtual objects, one or more virtual portals, one or more virtual icons, one or more textual objects, one or more graphical objects, one or more guardians, or any combination thereof. For example, content overlay module 438 can overlay virtual drumsticks in a particular location in the pass-through view of the real-world environment. In another example, content overlay module 438 can overlay a guardian representing the boundary of a region within a room on the region boundary, the boundary of the region being the pre-mapped portion of the room. In still another example, content overlay module 438 can overlay a virtual doorway with a preview of the VR experience on a region of the floor of a living room, the region of the floor being the pre-mapped portion of the living room. In some implementations in which pre-mapped portion identification module 436 identifies multiple pre-mapped portions of a physical space in the pass-through view of the real-world environment, content overlay module 438 can display multiple content overlays corresponding to respective VR experiences at respective pre-mapped portions of the physical space. Further details regarding displaying a content overlay that corresponds to a VR experience at a pre-mapped portion of a physical space are described herein with respect to block 506 of FIG. 5.

User input determination module 440 can determine that user input received at the XR device interacts with the content overlay. The user input can include one or more of, for example, a gesture, a gaze, a point-and-click of a finger on a virtual button (or of the content overlay itself), a point-and-click of a physical button (or other selection via a physical button), an audible announcement (e.g., “I want to launch the VR soccer experience.”), a movement (e.g., a movement toward or within the content overlay), etc. When received as audible user input, it is contemplated that user input determination module 440 can perform speech recognition techniques to parse the announcement into input recognizable and/or understandable by the XR device (e.g., a speech-to-text transcript). In implementations in which pre-mapped portion identification module 436 identifies multiple pre-mapped portions of a physical space in the pass-through view of the real-world environment and content overlay module 438 displays multiple content overlays corresponding to respective VR experiences at respective pre-mapped portions of the physical space, user input determination module 440 can further determine which content overlay the user input interacts with, such as through eye tracking, movement tracking, hand tracking, gesture tracking, speech recognition and/or natural language techniques, etc. Further details regarding determining that user input received at the XR device interacts with a content overlay are described herein with respect to block 508 of FIG. 5.

VR experience launch module 442 can, based on user input determination module 440 determining that user input received at the XR device interacts with a content overlay, launch the corresponding VR experience on the XR device. The VR experience can present, via the XR device, an artificial environment replacing the pass-through view of the real-world environment on the XR device. In other words, the VR experience can be a fully immersive, computer-generated artificial experience displayed on the XR device, without a pass-through view of the real-world environment. Further details regarding launching a VR experience on an XR device are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for providing an artificial reality (XR) entry space for a virtual reality (VR) experience. In some implementations, process 500 can be performed as a response to activation or donning of an XR device by a user. In some implementations, some or all of the blocks of process 500 can be performed by an XR device. In some implementations, the XR device can be an XR head-mounted display (HMD), such as HMD 200 of FIG. 2A and/or HMD 252 of FIG. 2B. In some implementations, some of the blocks of process 500 can be performed by another device in an XR system, such as processing components in operable communication with the XR device. In some implementations, some of the blocks of process 500 can be performed by a server located remotely from the XR device, such as a platform computing system or developer computing system. In some implementations, process 500 can be performed by XR entry space system 164 of FIG. 1. In some implementations, process 500 can be performed by specialized components 430 of FIG. 4.

At block 502, process 500 can detect activation or donning of an XR device by a user. In some implementations, process 500 can detect activation or donning of the XR device automatically, e.g., through one or more sensors of an inertial measurement unit (IMU), through temperature sensors, etc., integral with the XR device. In some implementations, process 500 can detect activation of the XR device by selection of a physical button powering on the XR device. In some implementations, process 500 can detect activation of the XR device based on receipt of power to the XR device, e.g., through a power cable or battery. Alternatively or additionally, process 500 can detect launch of an application associated with an XR experience on the XR device.

Upon activation or donning of the XR device, the XR device can at least partially display a pass-through view of a real-world environment. In some implementations, the pass-through view can be generated based on images of the real-world environment captured by one or more image capture devices (e.g., cameras) integral with or in operable communication with the XR device, such as in augmented reality (AR) as used herein. In some implementations, the pass-through view can be a real view of the real-world environment that can be seen through the XR device, such as in mixed reality (MR) as used herein. In some implementations, upon activation or donning of the XR device, the XR device can display one or more virtual objects overlaid on the pass-through view of the real-world environment. For example, the XR device can display a virtual tablet overlaid on the pass-through view of the real-world environment, as described further herein with respect to FIG. 6.

At block 504, process 500 can identify a pre-mapped portion of a physical space in the pass-through view of the real-world environment. The pre-mapped portion can be, for example, a desktop in a physical space (e.g., an office) seen in the pass-through view of the real-world environment on the XR device. In another example, the pre-mapped portion can be the floor in a living room seen in the pass-through view of the real-world environment. The pre-mapped portion can be mapped to a virtual reality (VR) experience. For example, an identifier associated with the pre-mapped portion can be stored in association with an identifier of a particular VR experience, such as in a lookup table in a database. In some implementations, the pre-mapped portion can be mapped to multiple VR experiences.

In some implementations, the pre-mapped portion was previously mapped to the VR experience by the user of the XR device via the XR device. For example, the user can use the XR device to select a portion of the physical space (e.g., region or volume) to which to map the VR experience. In some implementations, the user can select the portion of the physical space using one or more controllers in operable communication with the XR device, e.g., one or more of controllers 276A-276B of FIG. 2C. For example, the user can place the controller on the physical space and outline the portion of the physical space to which to map a VR experience. In another example, the user can use the controller to draw a boundary (e.g., a guardian) of the portion of the physical space to which the user wants to map a VR experience, such as by pointing and moving the controller around the portion of the physical space while holding down a physical button on the controller.

In some implementations, the user can select the portion of the physical space to which to map the VR experience by audibly announcing the portion of the physical space, e.g., by speaking, “the counter,” as captured by one or more microphones integral with or in operable communication with the XR device. In some implementations, the XR device (or a processing component in operable communication with the XR device) can then perform speech recognition techniques to identify what the user has spoken. In some implementations, the user can select the portion of the physical space from a virtual list of recognized physical objects within the physical space (e.g., the floor, the wall, the desk, the chair, the couch, etc.). For example, one or more computer vision models can perform object detection and recognition on the captured images of the real-world environment, and the recognized objects can populate the virtual list. In some implementations, the XR device (or processing components in operable communication with the XR device) can also perform the object recognition and/or object detection techniques to identify the portion of the physical space referenced in the user's announcement and/or selection.

Once the portion of the physical space is identified, the user can map the portion of the physical space to a particular VR experience by, for example, selecting a particular VR experience from a list of available VR experiences, searching for a particular VR experience in a library of VR experiences, audibly announcing the VR experience (e.g., “I want to map the counter to a VR cooking experience”), etc. In some implementations, the user can further specify access controls for who can access the mapping, e.g., any other users and/or XR devices permitted to use the mapping. In some implementations, the mapping can be user- and/or device-specific, i.e., the mapping only pertains to that user and/or that XR device. In some implementations, the pre-mapped portion was previously mapped to the VR experience by another user of the XR device, and the other user may have permitted the user to access the mapping. In some implementations, the mapping can be stored locally on the XR device. In some implementations, the mapping can be stored on a system or device over a network, e.g., network 330 of FIG. 3, such as on a cloud.

In some implementations, the pre-mapped portion was previously mapped to the VR experience using another XR device, e.g., by the user on another XR device and/or by another user on another XR device. For example, another XR device can be used to generate the mapping (and, in some implementations, delineate access controls for the mapping), and upload the mapping to the cloud. When the user enters the physical space with the XR device, the XR device can query the cloud for mappings within the physical space to which the XR device has access, and download any available mappings for the physical space (and/or for certain pre-mapped portions within the physical space, such as pre-mapped portions within the pass-through view on the XR device).

In some implementations, the pre-mapped portion of the physical space was previously mapped to the VR experience automatically, such as by one or more previous steps of process 500. In some implementations, the pre-mapped portion of the physical space can be mapped automatically to a VR experience based on a defined category of the pre-mapped portion relative to the VR experience. For example, the pre-mapped portion can have a category consistent with a category of the VR experience, such as a desk being categorized for office work, and a VR experience being categorized for office work. In some implementations, the pre-mapped portion of the physical space can be mapped automatically to a VR experience based on one or more features and/or requirements of the VR experience with respect to one or more features of the pre-mapped portion of the physical space. For example, the VR experience may require a large amount of movement (e.g., a VR dancing experience), and this VR experience can automatically be mapped to portions of the physical space having a size large enough to accommodate movement (e.g., large open floor areas, high clearance on the ceilings, etc.).

In some implementations, the pre-mapped portion can be mapped to the VR experience automatically based on the user's previous access of the VR experience, such as by one or more previous steps of process 500. For example, the pre-mapped portion can be mapped to the VR experience because the user last accessed the VR experience while physically located in the pre-mapped portion, the user has accessed the VR experience while physically located in the pre-mapped portion a threshold number of times (e.g., 3, 5, 10, etc.), the user frequently accesses the VR experience while in the pre-mapped portion (e.g., the user accesses the VR experience instead of other VR experiences 75% of the time while in the pre-mapped portion), etc.

For example, process 500 can determine that the VR experience was accessed by the XR device, determine one or more locations in the physical space corresponding to where the XR device was located when the VR experience was accessed, and define the determined one or more locations in the physical spaced as the pre-mapped portion. Process 500 can then associate the pre-mapped portion with the VR experience. Process 500 can determine the one or more locations in the physical space corresponding to where the XR device was located when the VR experience was accessed by any suitable method. For example, process 500 can determine the one or more locations by triangulating the location of the XR device with respect to two or more spatial anchors established for the physical space. Alternatively or additionally, process 500 can determine the one or more locations by performing object recognition and/or object detection while the user is accessing the VR experience, and comparing the view of the recognized objects to previously stored scene data associated with the physical space.

In some implementations, the pre-mapped portion can be mapped to the VR experience using a machine learning model trained on one or more of: data specific to the user of the XR device (e.g., demographics of the user, habits of the user, schedule of the user, interests of the user, VR experiences previously accessed by the user, VR experiences previously accessed by the user in particular portions of the physical space, calendar data of the user, etc.), data related to other users similarly situated as or associated with the user (e.g., friends of the user, other users having similar demographics, other users having similar interests, VR experiences previously accessed by other users, VR experiences previously accessed by other users in particular portions of a physical space, etc.), data regarding available VR experiences (e.g., categories, features, requirements including any user requirements and/or restrictions, descriptions, etc.), contextual data (e.g., time of day, time of year, weather, indoor or outdoor location, size of the portion of the physical space, location of the physical space, location of the portion within the physical space, other users within the physical space, physical objects within the physical space, etc.), or any combination thereof. The machine learning model can receive input data regarding a portion of a physical space, and apply the trained model to predict a VR experience that the user would likely want to access in the portion of the physical space. In some implementations, the prediction can be provided to the user via the XR device, and the user can provide explicit or implicit feedback as to whether the prediction was correct or incorrect to further refine the model. For example, the user can audibly announce that the prediction is good or bad, can select a virtual button indicating whether the prediction is good or bad, can accept or deny the suggested mapping, can fail to correct the suggested mapping, etc. Based on the prediction and/or any feedback, the portion of the physical space can be mapped to the VR experience, and the machine learning model can be updated and/or refined.

In some implementations, process 500 can identify multiple pre-mapped portions of a physical space in the pass-through view of the real-world environment. In some implementations each pre-mapped portion of the multiple pre-mapped portions can be mapped to a VR experience. In some implementations, one or more of the multiple pre-mapped portions can be mapped to the same VR experience. In some implementations, one or more of the multiple pre-mapped portions can be mapped to different VR experiences. In some implementations, two or more of the multiple pre-mapped portions can at least partially overlap in the physical space. For example, an entire living room can be mapped to one or more VR experiences, while a couch within the living room can also be mapped to one or more of the same or different VR experiences. In another example, a first portion of a living room floor can be mapped to one or more VR experiences, while a second portion of the living room floor can be mapped to one or more of the same or different VR experiences, with the first and second portions of the floor partially overlapping. In some implementations, the overlapping portion can be mapped to all of the VR experiences corresponding to the pre-mapped portions within the overlapping portion.

At block 506, process 500 can display a content overlay that corresponds to the VR experience at the pre-mapped portion of the physical space. The content overlay can be virtual content overlaid on the pass-through view of the real-world environment. In some implementations, the content overlay can include a virtual object associated with the VR experience. For example, the virtual object can be a virtual microphone associated with a VR karaoke experience. In another example, the virtual object can be a virtual bat associated with a VR baseball experience. In some implementations, the content overlay can include animated virtual objects, such as a microphone with animated musical notes above it, a swinging virtual bat, etc.

In some implementations, the content overlay can include a guardian defining a boundary of the pre-mapped portion in the physical space in which the user can access the VR experience via the XR device (e.g., a floor area, a desktop area, a countertop area, a couch, a table, etc.). In some implementations, the guardian can define a boundary of the physical space in the real-world environment in which the user is permitted to use the XR device, e.g., empty floor space in a room without any impeding physical objects. In some cases, the pre-mapped portion of the physical space can be an area and content overlaid at the pre-mapped portion can be floating or attached to another virtual object (e.g., a virtual wall created at the border of the pre-mapped portion).

In some implementations, the content overlay can include a virtual portal associated with virtual travel to the VR experience. The portal can be any graphical and/or textual indicator of the VR experience, such as a name of the VR experience, a description of the VR experience, a virtual door to the VR experience, a snapshot and/or preview of the VR experience, etc. In some implementations in which process 500 identifies multiple pre-mapped portions within a physical space, process 500 can display a content overlay at each pre-mapped portion of the physical space. The content overlay for each pre-mapped portion of the physical space can be the same or different than one or more of the content overlays for the other of the multiple pre-mapped portions of the physical space. For example, a first content overlay corresponding to a first VR experience can be a guardian, while a second content overlay corresponding to a second VR experience can be a virtual object.

At block 508, process 500 can determine that user input received at the XR device interacts with the content overlay. The user input can include, for example, input via a physical button (e.g., a physical button on the XR device or another device in operable communication with the XR device, such as one or more controllers), detection of a gesture by the user captured by one or more cameras and/or sensors integral with or in operable communication with the XR device (e.g., a grabbing gesture, such as to grab a virtual object in the content overlay, a pointing gesture, etc.), an audible announcement captured by one or more microphones integral with or in operable communication with the XR device (e.g., “I want to go to the VR world you're showing me in the preview”), a movement by the user (e.g., physically moving within a guardian) as detected by one or more cameras and/or sensors integral with or in operable communication with the XR device, and/or the like. In some implementations in which multiple content overlays are displayed on the XR device, process 500 can further determine to which content overlay the user input is directed.

At block 510, based on the user input that interacts with the content overlay, process 500 can launch the VR experience on the XR device. The VR experience can present an artificial environment (i.e., a fully immersive, three-dimensional computer-generated environment) that replaces the pass-through view of the real-world environment on the XR device. For example, based on a user's gesture of grabbing a virtual bat overlaid on the real-world environment, process 500 can launch a VR baseball experience on the XR device. In another example, based on a user entering a guardian on the real-world living room floor, process 500 can launch a VR boxing experience on the XR device. In still another example, based on a user selection of a virtual portal previewing a VR volleyball experience displayed on the XR device (or, in some embodiments, the user walking through the virtual portal, either by moving her body or by using one or more controllers to direct movement of an avatar), process 500 can launch the VR volleyball experience on the XR device.

In some implementations, process 500 can launch the VR experience on the XR device in accordance with a stored state of the VR experience. Based on previous access of the VR experience by the user on the XR device (i.e., prior to performance of process 500), the XR device can capture the stored state as an indicator of where in the VR experience the user was when the VR experience was exited. The stored state can include, for example, a particular time in the VR experience (such as a particular point in the three-dimensional movie, a VR concert, etc.), stored progress (e.g., within a VR game), which virtual objects were present in the VR experience and where, etc. Thus, when the user again launches the VR experience on the XR device (e.g., at block 510 of process 500), the VR experience can pick up where the user left off previously.

In some implementations, the user can exit the VR experience by, for example, removing the XR device, deactivating the XR device (e.g., turning off a power button, the XR device running out of power, etc.), closing the VR experience, moving outside of the pre-mapped portion mapped to the VR experience, etc. In some implementations, when the user exits the VR experience, the XR device can revert to displaying at least a partial pass-through view of the real-world environment of the user, i.e., revert to an MR or AR experience. In some implementations, when the user exits the VR experience, the XR device can automatically display a virtual tablet overlaid on the pass-through view of the real-world environment. Further details regarding displaying a virtual tablet are described herein with respect to FIG. 6.

FIG. 6 is a conceptual diagram of an example view 600 on an XR device of a virtual tablet 604 overlaid on a pass-through view 602 of a real-world environment. In some implementations, upon donning or activation of the XR device, the XR device can automatically display virtual tablet 604 overlaid on pass-through view 602, without further action by a user wearing the XR device. In some implementations, the XR device can display only pass-through view 602 of the real-world environment upon donning or activation, and can launch virtual tablet 604 in response to user input, e.g., an audible command, a gesture, a selection of a physical or virtual button, etc.

In some implementations, pass-through view 602 can be captured by one or more cameras integral with or in operable communication with the XR device, directed away from the user's face toward the real-world environment. Once captured, pass-through view 602 can be streamed to the display of the XR device to the user, as in augmented reality (AR). In some implementations, pass-through view 602 can be a real view of the real-world environment as seen by the user through the XR device, as in mixed reality (MR).

In some implementations, virtual tablet 604 can be a system tablet and/or home screen for the XR device. Virtual tablet 604 can include, for example, virtual portals 608A-608D to XR applications, such as AR, MR, and/or VR applications. In some implementations, virtual portals 608A-608D can be displayed in virtual tablet 604 based on, for example, frequency of launch of and/or access to their respective XR applications, which XR applications were most recently launched and/or accessed, etc. In some implementations, virtual tablet 604 can include utilities 606, such as an e-mail and/or messaging application, an alarm application, a note taking application, a camera and/or video application, a contacts or friends list application, etc.

In some implementations, while within a VR experience, the user of the XR device can exit the VR experience, and the XR device can automatically display virtual tablet 604 overlaid on pass-through view 602 of the real-world environment. In some implementations, while within a VR experience, the user of the XR device can exit the VR experience, and the XR device can automatically display pass-through view 602 of the real-world environment, and only display virtual tablet 604 in response to further user input. In some implementations, virtual tablet 604 can be accessed from within a VR experience, and can be overlaid on the VR experience in response to user input, such as a selection of a virtual and/or physical home button, through a gesture (e.g., looking at the inside of the user's wrist), through an audible command (e.g., “show my virtual tablet”), etc.

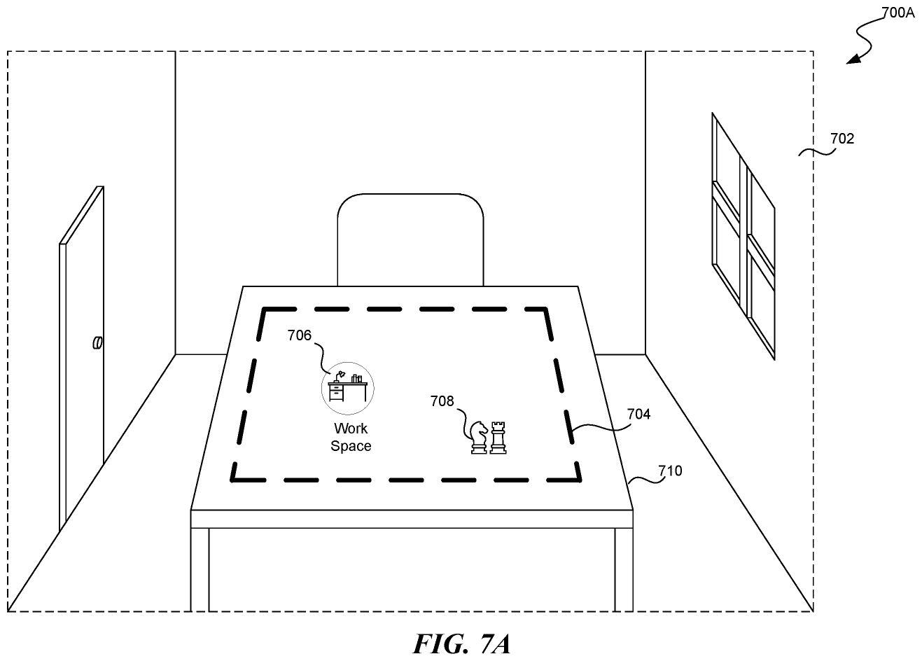

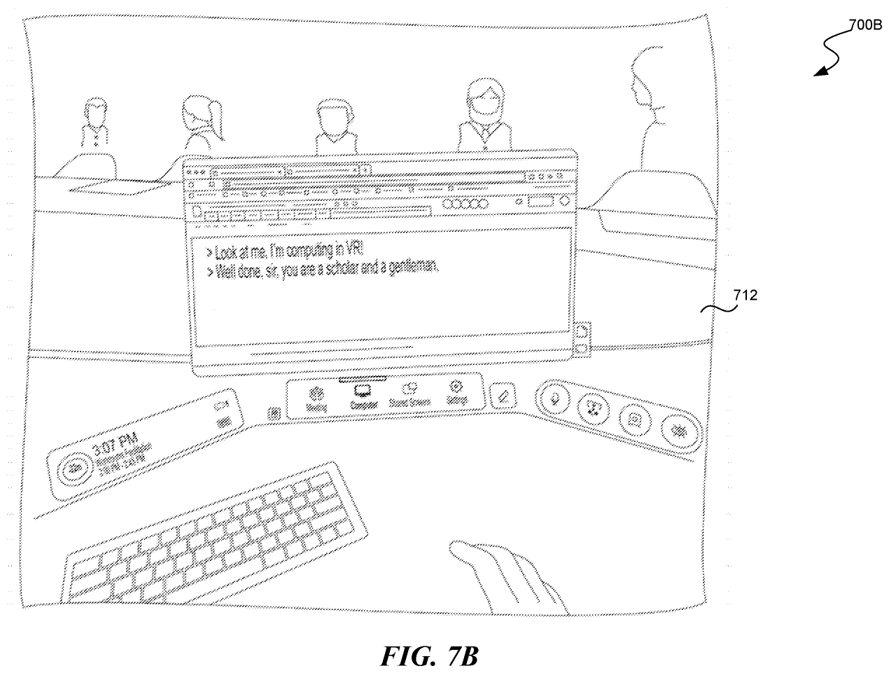

FIG. 7A is a conceptual diagram of an example view 700A on an XR device of content overlays 706-708 overlaid on a pre-mapped portion 704 of a physical space 702 in a real-world environment. Physical space 702 can be displayed on the XR device as a pass-through view, as described further herein. In example view 700A, physical space 702 can be a room including table 710. Pre-mapped portion 704 can be a portion of the tabletop of table 710. In some implementations, the XR device can display pre-mapped portion 704 in view 700A, while in other implementations, the view of pre-mapped portion 704 can be omitted.

Pre-mapped portion 704 can be associated with two VR experiences: a VR work space experience 712 of FIG. 7B associated with content overlay 706, and a VR chess experience associated with content overlay 708. Content overlay 706 can be, for example, a virtual portal with which the user of the XR device can interact in order to launch the associated VR work space experience 712. For example, the user can select content overlay 706 by, for example, making a gesture (e.g., pointing at content overlay 706), selecting a physical button (e.g., a physical button on the XR device and/or on one or more controllers in operable communication with the XR device, such as controllers 276A-B of FIG. 2C), selecting content overlay 706 as a virtual button (e.g., by pointing at and tapping content overlay 706), making an audible announcement (e.g., “I want to launch the VR work space experience”), etc.

Content overlay 708 can include, for example, one or more virtual objects, such as virtual chess pieces. The user of the XR device can interact with content overlay 708 in order to launch the associated VR chess experience. For example, in some implementations, the user can use his hand (and/or one or more controllers in operable communication with the XR device, such as controllers 276A-B of FIG. 2C) to grab, pick up, and/or move the chess pieces shown as content overlay 708. In some implementations, such an interaction with content overlay 708 can be interpreted as user input to launch the VR chess experience.

In some implementations, the VR work space experience 712 (associated with content overlay 706) and the VR chess experience (associated with content overlay 708) were previously mapped to pre-mapped portion 704, such that content overlays 706-708 are automatically displayed in example view 700A when the user of the XR device is in physical space 702, with pre-mapped portion 704 in view. In some implementations, the user of the XR device manually mapped VR work space experience 712 (associated with content overlay 706) and the VR chess experience (associated with content overlay 708) to pre-mapped portion 704, as described further herein with respect to FIG. 5.

In some implementations, the XR device, another XR device within an XR system (e.g., processing components in operable communication with the XR device), and/or a remote server (e.g., a platform computing system in operable communication with the XR device over a network, such as network 330 of FIG. 3) automatically mapped VR work space experience 712 and the VR chess experience to pre-mapped portion 704, without further user input. For example, VR work space experience 712 and the VR chess experience could have been mapped to pre-mapped portion 704 based on any of a number of factors, such as a category and/or feature(s) of pre-mapped portion 704, a category and/or feature(s) of physical space 702, a category and/or feature(s) of VR work space experience 712, a category and/or feature(s) of the VR chess experience, which VR experience(s) were previously used at pre-mapped portion 704 by the user and/or the XR device, which VR experience(s) were most recently used at pre-mapped portion 704 by the user and/or the XR device, which VR experience(s) are most frequently used at pre-mapped portion 704 by the user and/or the XR device, etc. In some implementations, VR work space experience 712 and the VR chess experience were mapped to pre-mapped portion 704 based on output of a machine learning model trained to predict which VR experience(s) the user is mostly likely to access at pre-mapped portion 704 and/or physical space 702, as described further herein with respect to FIG. 5. Although described herein as being pre-mapped, it is contemplated that VR work space experience 712 and/or the VR chess experience can be mapped to portion 704 of physical space 702 “on the fly,” e.g., in real-time or near real-time, using the techniques described herein.

FIG. 7B is a conceptual diagram of an example view 700B on an XR device of a VR work space experience 712 accessed from content overlay 706 overlaid on a pre-mapped portion 704 of a physical space 702 in a real-world environment. For example, from example view 700A of FIG. 7A, the user of the XR device can interact with content overlay 706 corresponding to VR work space experience 712. As described further herein with respect to FIG. 7A, the user can select content overlay 706 by, for example, making a gesture, selecting a physical button, selecting content overlay 706 as a virtual button, making an audible announcement, etc. In response to receiving this interaction as user input, the XR device can launch VR work space experience 712, which can be displayed as a fully immersive, computer-generated artificial environment replacing the pass-through view of physical space 702 of FIG. 7A.

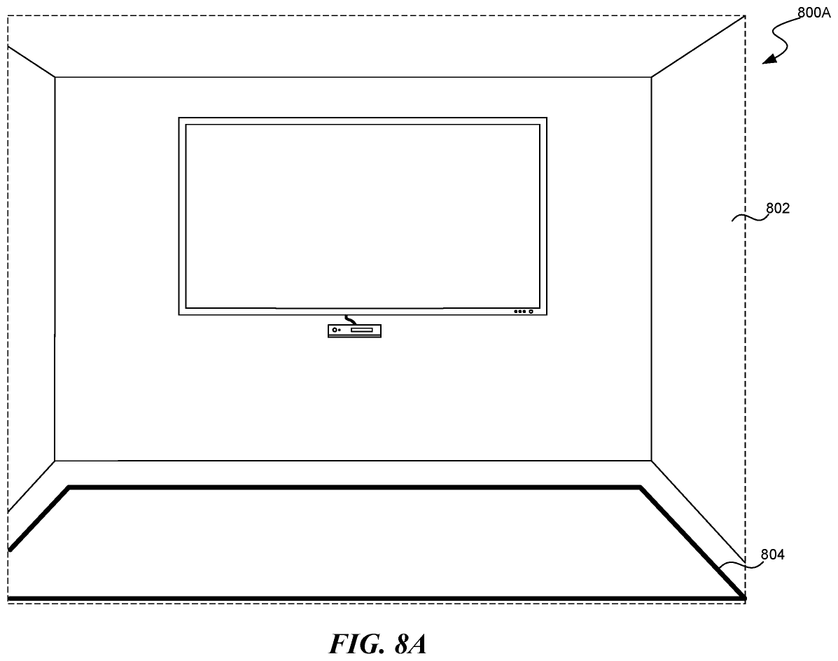

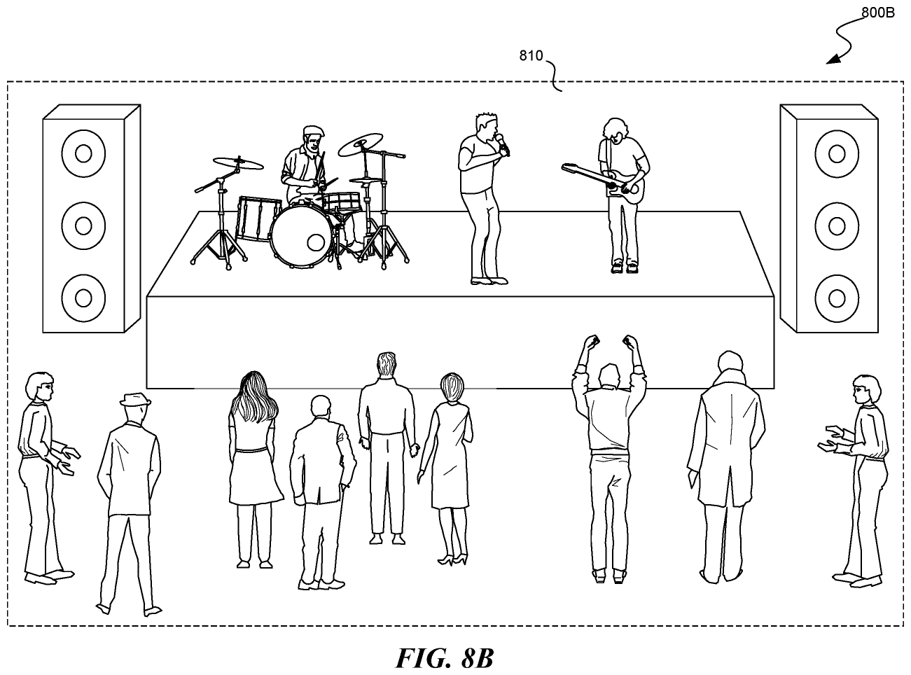

FIG. 8A is a conceptual diagram of an example view 800A on an XR device of a guardian 804 overlaid on a pre-mapped portion (not shown) of a physical space 802 in a real-world environment. As shown in example view 800A, the pre-mapped portion (not shown) of physical space 802 in the real-world environment need not be displayed on the XR device in some implementations. In some implementations, the pre-mapped portion (not shown) can correspond to and/or fully encompass guardian 804. Physical space 802 can be, for example, a living room in a real-world environment, that is shown as a pass-through view (e.g., as in AR or MR) on the XR device, as described further herein.

When the pre-mapped portion (not shown) of physical space 802 is within view of the user of the XR device, the XR device can retrieve and display a content overlay (e.g., guardian 804) corresponding to a VR experience 810. In example view 800A, the XR device can omit any identifying features of the corresponding VR experience 810 in some implementations. The XR device can omit identifying features of the corresponding VR experience 810 because, for example, only one VR experience 810 is associated with the pre-mapped portion (not shown), and/or only one content overlay (i.e., guardian 804) is retrieved and displayed corresponding to the pre-mapped portion (not shown). In some implementations, however, the XR device can include a name, descriptor, preview, snapshot, etc., related to VR experience 810 in conjunction with guardian 804. In order to launch the corresponding VR experience 810, the user of the XR device can provide user input that interacts with guardian 804.

FIG. 8B is a conceptual diagram of an example view 800B on an XR device of a VR experience 810 automatically launched in response to a user interaction with a guardian 804 overlaid on a pre-mapped portion (not shown) of a physical space 802 in a real-world environment. In example view 800B, VR experience 810 can be a VR concert experience. The XR device can display VR experience 810 as a fully immersive, computer-generated artificial environment replacing the pass-through view of physical space 802 of FIG. 8A.

The XR device can launch VR experience 810 to generate example view 800B in response to user input, e.g., a user interaction with guardian 804. For example, the XR device can launch VR experience 810 in response to the user of the XR device entering guardian 804. For example, the user can physically move into guardian 804. Upon entering guardian 804, the XR device can automatically launch VR experience 810, for example, if VR experience 810 is the only VR experience mapped to the pre-mapped portion (not shown) of physical space 802. In another example, the XR device can automatically launch VR experience 810 if VR experience 810 was the last VR experience accessed within the pre-mapped portion (not shown) of physical space 802. In some implementations, the XR device can automatically select and launch VR experience 810 based on any of a number of other factors described herein, such as based on output of a machine learning model trained to predict that VR experience 810 should be mapped to the pre-mapped portion of physical space 802. In some implementations, the XR device can pick up where the user left off in VR experience 810, such as if the user exited VR experience 810 before it was complete, using, for example, a stored state of VR experience 810, as described further herein with respect to FIG. 5.

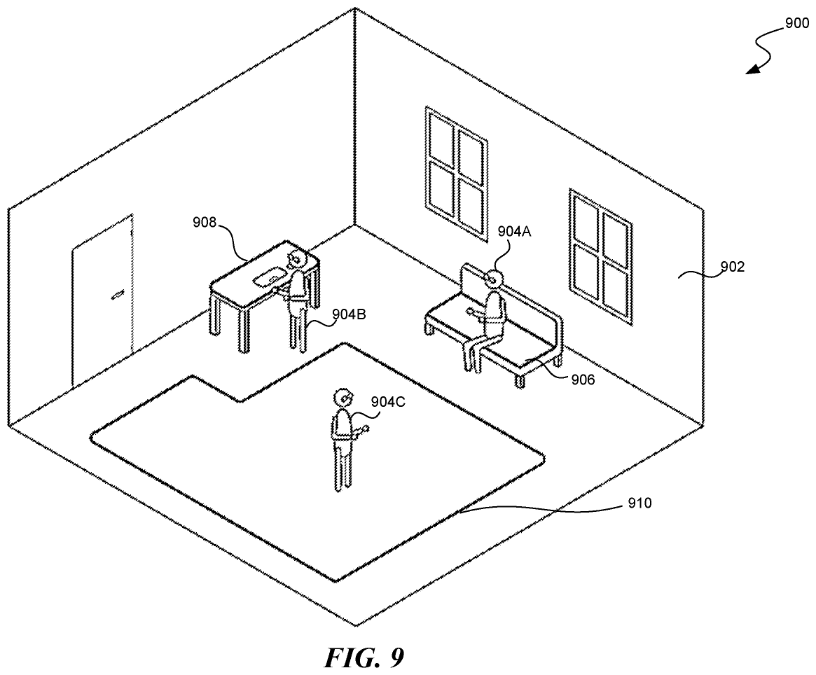

FIG. 9 is a conceptual diagram of an example view 900 of a real-world environment including users 904A-C of respective XR devices accessing virtual reality VR experiences at respective pre-mapped portions 906-910 of a physical space 902. As shown in example view 900, a single physical space 902 can have multiple pre-mapped portions 906-910 mapped to the same and/or different VR experiences. For example, the XR device of user 904A can launch a first VR experience (e.g., a VR film) within pre-mapped portion 906 (e.g., a couch) by interacting with a first content overlay (e.g., a virtual portal), the XR device of user 904B can launch a second VR experience (e.g., a VR office) within pre-mapped portion 908 by interacting with a second content overlay (e.g., entering a guardian), and the XR device of user 904C can launch a third VR experience (e.g., a VR boxing game) within pre-mapped portion 910 by interacting with a third content overlay (e.g., picking up virtual boxing gloves).

Although shown and described with respect to three users 904A-904C in three pre-mapped portions 906-910, it is contemplated that physical space 902 can include any number of users within or outside of any number of pre-mapped portions. Although shown as separate and distinct pre-mapped portions 906-910, it is contemplated that one or more of pre-mapped portions 906-910 can partially or fully overlap. Further, although shown as users 904A-904C being within respective pre-mapped portions 906-910, it is contemplated that two or more of users 904A-904C can be within a single pre-mapped portion of pre-mapped portions 906-910. In such implementations, it is contemplated that two or more of users 904A-904C within a single pre-mapped portion of pre-mapped portions 906-910 can interact in the same or different ways with the same or different content overlays associated with the same or different VR experiences, in order to launch the same or different VR experiences from within a single pre-mapped portion.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing an artificial reality entry space for a virtual reality experience, the method comprising:
detecting activation or donning of an artificial reality device by a user, the artificial reality device at least partially displaying a pass-through view of a real-world environment of the user upon activation or donning;
identifying at least two pre-mapped portions of a physical space of the real-world environment, wherein a first of the pre-mapped portions is mapped to a first virtual reality experience and a second of the pre-mapped portions is mapped to a second virtual reality experience;
displaying a first content overlay that corresponds to the first virtual reality experience at the first pre-mapped portion of the physical space and a second content overlay that corresponds to the second virtual reality experience at the second pre-mapped portion of the physical space;
determining that user input received at the artificial reality device interacts with the first content overlay; and
based on the user input that interacts with the first content overlay, launching the first virtual reality experience on the artificial reality device, the first virtual reality experience presenting an artificial environment replacing the pass-through view of the real-world environment on the artificial reality device.

2. The method of claim 1, wherein the first content overlay is a virtual object associated with the first virtual reality experience.

3. The method of claim 1, wherein the first content overlay is a guardian defining a boundary of the first pre-mapped portion in the physical space in which the user can access the first virtual reality experience via the artificial reality device.

4. The method of claim 3, wherein the user input that interacts with the first content overlay is movement into the guardian by the user.

5. The method of claim 1, wherein the first content overlay is a virtual portal to the first virtual reality experience, the virtual portal being displayed on the artificial reality device.

6. The method of claim 1, wherein the first pre-mapped portion overlaps with the second pre-mapped portion in the physical space.

7. The method of claim 1, wherein the first pre-mapped portion of the physical space was mapped to the first virtual reality experience by the user via the artificial reality device.

8. The method of claim 1, wherein the first pre-mapped portion of the physical space was mapped to the first virtual reality experience automatically based on a defined category of the first pre-mapped portion of the physical space relative to the first virtual reality experience.

9. The method of claim 1, wherein the first pre-mapped portion of the physical space was previously mapped to the first virtual reality experience by:
determining one or more locations in the physical space corresponding to where the artificial reality device was located when previously accessing the first virtual reality experience;
defining the determined one or more locations in the physical space as the first pre-mapped portion; and
associating the first pre-mapped portion with the first virtual reality experience.

10. The method of claim 1, wherein the first virtual reality experience is launched on the artificial reality device in accordance with a stored state of the first virtual reality experience, the stored state being captured when the user previously exited the first virtual reality experience on the artificial reality device.

11. A computer-readable storage medium storing instructions that, when executed by a computing system, cause the computing system to perform a process for providing an artificial reality entry space for a virtual reality experience, the process comprising:
detecting activation or donning of an artificial reality device by a user, the artificial reality device at least partially displaying a pass-through view of a real-world environment of the user upon activation or donning;
identifying a pre-mapped portion of a physical space of the real-world environment, wherein the pre-mapped portion is mapped to a virtual reality experience;
displaying a content overlay that corresponds to the virtual reality experience at the pre-mapped portion of the physical space;
determining that user input received at the artificial reality device interacts with the content overlay; and
based on the user input that interacts with the content overlay, launching the virtual reality experience on the artificial reality device, the virtual reality experience presenting an artificial environment replacing the pass-through view of the real-world environment on the artificial reality device.

12. The computer-readable storage medium of claim 11, wherein the pre-mapped portion is a first pre-mapped portion, wherein the virtual reality experience is a first virtual reality experience, wherein the content overlay is a first content overlay, and wherein the process further comprises:
identifying a second pre-mapped portion of the physical space in the pass-through view of the real-world environment, wherein the second pre-mapped portion is mapped to a second virtual reality experience; and
displaying a second content overlay that corresponds to the second virtual reality experience at the second pre-mapped portion of the physical space.

13. The computer-readable storage medium of claim 12, wherein the first pre-mapped portion overlaps with the second pre-mapped portion in the physical space.

14. The computer-readable storage medium of claim 11, wherein the content overlay is a virtual object associated with the virtual reality experience.

15. The computer-readable storage medium of claim 11, wherein the content overlay is a guardian defining a boundary of the physical space in the real-world environment in which the user is permitted to use the artificial reality device.

16. The computer-readable storage medium of claim 11, wherein the content overlay is a virtual portal to the virtual reality experience, the virtual portal being displayed on the artificial reality device.

17. A computing system for providing an artificial reality entry space for a virtual reality experience, the computing system comprising:
one or more processors; and
one or more memories storing instructions that, when executed by the one or more processors, cause the computing system to perform a process comprising:
detecting activation or donning of an artificial reality device by a user, the artificial reality device at least partially displaying a pass-through view of a real-world environment of the user upon activation or donning;
identifying a pre-mapped portion of a physical space of the real-world environment, wherein the pre-mapped portion is mapped to a virtual reality experience;
displaying a content overlay that corresponds to the virtual reality experience at the pre-mapped portion of the physical space;
determining that user input received at the artificial reality device interacts with the content overlay; and
based on the user input that interacts with the content overlay, launching the virtual reality experience on the artificial reality device, the virtual reality experience presenting an artificial environment replacing the pass-through view of the real-world environment on the artificial reality device.

18. The computing system of claim 17, wherein the pre-mapped portion is a first pre-mapped portion, wherein the virtual reality experience is a first virtual reality experience, wherein the content overlay is a first content overlay, and wherein the process further comprises:
identifying a second pre-mapped portion of the physical space in the pass-through view of the real-world environment, wherein the second pre-mapped portion is mapped to a second virtual reality experience; and
displaying a second content overlay that corresponds to the second virtual reality experience at the second pre-mapped portion of the physical space.

19. The computing system of claim 17, wherein the pre-mapped portion of the physical space was mapped to the virtual reality experience automatically based on a defined category of the pre-mapped portion of the physical space relative to the virtual reality experience.

20. The computing system of claim 17, wherein the virtual reality experience is launched on the artificial reality device in accordance with a stored state of the virtual reality experience, the stored state being captured when the user previously exited the virtual reality experience on the artificial reality device.
